(19) United States
(12) Patent Application Publication
(10) Pub. No.: US 2025/0106955 A1
(43) Pub. Date: Mar. 27, 2025

(54) HEATING COIL FOR HIGH-FREQUENCY HEATER

(71) Applicant: TKE Co.,Ltd, Yatomi-shi, Aichi (JP)

(72) Inventors: Hideaki ITO, Yatomi-shi, Aichi (JP); Kazuhiro ABE, Yatomi-shi, Aichi (JP)

(21) Appl. No.: 18/713,594

(22) PCT Filed: Mar. 30, 2022
(86) PCT No.: PCT/JP2022/016284

§ 371 Date: Dec. 12, 2024

(30) Foreign Application Priority Data
Nov. 26, 2021 (JP) 2021-192496

(51) Int. Cl. H05B 6/42

(52) U.S. Cl. CPC H05B 6/42; H05B 2206/02

(57) ABSTRACT

Problem

Provided is a heating coil for high-frequency heater that is not easily damaged, has good cooling efficiency for a material to be worked, and can be inexpensively and easily manufactured having the same property with good reproducibility during manufacturing even when output of the high-frequency power supply is increased.

Solution

A heating coil 1 is integrally formed by a modeling method repeating laying, melting, solidifying, and laminating of a powder containing a conductive material based on three-dimensional data, and includes a pair of plate-shaped grounding portions 2a, 2b, a pair of plate-shaped supporting portions 3a, 3b, and an annular heating unit 4. The pair of grounding portions 2a, 2b are for contact with an electrode through which a high-frequency current is flowed. The pair of plate-shaped supporting portions 3a, 3b are disposed to be perpendicular to the respective grounding portions 2a, 2b. The annular heating unit 4 is disposed to connect distal ends of the supporting portions 3a, 3b to one another. The annular heating unit 4 includes a first cooling medium flow path 5 for cooling the material to be worked W after heating and a second cooling medium flow path 6 for cooling the heating unit 4 itself separately.

### TECHNICAL FIELD

The present invention relates to a heating coil used for a high-frequency heater for heating a material to be worked using electromagnetic induction by a high-frequency current.

### BACKGROUND ART

For increasing hardness of a portion close to a surface of a metal material to be worked (workpiece), processing (what is called, quenching process) in which the surface of the material to be worked is heated to a temperature equal to or more than a transformation point (austenite transformation point) of the metal, and then rapidly cooled is performed. As a method for performing the hardening process, a method in which a material to be worked is heated by bringing a metal member (heating coil) to which a high-frequency current has been flowed close to a surface of the material to be worked using a high-frequency heater is widely employed.

Conventional heating coils include a pair of grounding portions to be grounded to a high-frequency power supply, an annular coil portion to be fitted externally to a material to be worked, and a pair of connecting portions to connect the grounding portions to the coil portion. In addition, a general heating coil includes an insulating plate made of synthetic resin interposed between the pair of grounding portions and the pair of connecting portions, provided therewith, to prevent situation in which dielectric breakdown between the pair of grounding portions and the pair of connecting portions when the output of the high-frequency power supply is increased.

In the quenching process, the surface of the material to be worked need to be heated to a temperature equal to or higher than the transformation point of the metal and is then rapidly cooled. For this reason, some conventional heating coils include a coolant path inside the annular coil portion and a plurality of spray holes on an inner circumferential surface of the coil portion for spraying the cooling liquid filled in the coolant path to the material to be worked as shown in Patent Document 1.

### PRIOR ART

### Patent Document

Patent Document 1: Japanese Unexamined Patent Application Publication No. H06-279862

### DISCLOSURE OF THE INVENTION

### Problems to be Solved by the Invention

However, conventional heating coils such as those described in Patent Document 1 have the problem that the higher the output of the high-frequency power supply, the higher the heating amount of the coil portion and the higher the temperature of the cooling liquid flowing through the coolant path, resulting in a poor cooling efficiency of the material to be worked. In addition, the conventional heating coils as those described in Patent Documents 1 need to be formed by bonding a plurality of components with a silver wax or the like because a coolant path needs to be provided inside the coil portion. Therefore, the continuous use under a high output condition (under a processing condition of applying a high-frequency power supply of a high voltage) easily leads to a situation in which the cooling medium leaks out due to the damage. Furthermore, since the conventional heating coils as those described in Patent Documents 1 needs to be formed by brazing a plurality of components, it is difficult to manufacture the products having the same property with good reproducibility during manufacturing, and this causes a problem that variation occurs in the quality of the materials to be worked to be heated.

It is an object of the present invention to solve the above-mentioned problems of the conventional heating coils for high-frequency heating process, and to provide a heating coil for high-frequency heater that is not easily damaged, has good cooling efficiency for a material to be worked, and can be inexpensively and easily manufactured having the same property with good reproducibility during manufacturing even when output of the high-frequency power supply is increased.

### Solutions to the Problems

In the present invention, an invention described in claim 1 is a heating coil used for a high-frequency heater for heating a material to be worked using electromagnetic induction by a high-frequency current. The heating coil is integrally formed by a modeling method repeating laying, melting, solidifying, and laminating of a powder containing a conductive material based on three-dimensional data (hereafter referred to as a partial welding lamination method of conductive material powder layer), or a modeling method laminating a melted conductive material based on three-dimensional data (hereinafter referred to as a melt extrusion lamination method for the conductive material). The heating coil includes: a pair of plate-shaped grounding portions for contact with an electrode through which a high-frequency current is flowed; a pair of plate-shaped supporting portions disposed to be perpendicular to the respective grounding portions; and an annular heating unit disposed to connect distal ends of the supporting portions to one another. The annular heating unit includes a first cooling medium flow path for cooling the material to be worked after heating and a second cooling medium flow path for cooling the heating unit itself separately.

In an invention described in claim 2, which is in the invention described in claim 1, the first cooling medium flow path includes a plurality of spray holes for spraying the cooling medium to the material to be worked after heating.

In an invention described in claim 3, which is in the invention described in claim 1 or 2, the second cooling medium flow path is disposed inside the first cooling medium flow path.

In an invention described in claim 4, which is in the invention described in any one of claims 1 to 3, a portion of the second cooling medium flow path is formed inside each of the supporting portions.

### Effects of the Invention

The heating coil for a high-frequency heater (hereinafter simply referred to as “heating coil”) according to claim 1 is provided with a first cooling medium flow path for cooling the material to be worked after heating and a second cooling medium flow path for cooling the heating unit itself separately in the annular heating unit. Therefore, the cooling of the material to be worked after heating and the cooling of the heating unit itself can be performed efficiently at the same time. In addition, the heating coil is not easily damaged even when it is continuously used under high output conditions.

The heating coil according to claim 1 is formed by a partial welding lamination method of conductive material powder layer or a melt extrusion lamination method of conductive material based on three-dimensional data. Therefore, the heating coil can be considerably easily manufactured at low cost regardless of the complicated shape of the annular heating unit. Moreover, products having the same shape and the same characteristics can be efficiently manufactured with good reproducibility regardless of the skill of manufacturing workers. Furthermore, since the heating coil according to claim 1 is formed by a partial welding lamination method of conductive material powder layer or a melt extrusion lamination method of conductive material based on three-dimensional data, a bonding portion with a silver wax is not present different from the conventional heating coil. Therefore, even the temperature rise due to the continuous use does not cause deformation, and the heating process (quenching treatment) according to specifications can be performed over a long period of time.

In the heating coil according to claim 2, since the first cooling medium flow path for cooling the material to be worked after heating is provided with a plurality of spray holes for spraying the cooling medium to the material to be worked after heating. Thus, the material to be worked after heating can be efficiently cooled within a short time with a small amount of cooling medium.

In the heating coil according to claim 3, the second cooling medium flow path for cooling the heating unit itself is disposed inside the first cooling medium flow path. As a result, the cooling medium flows down near the part of the heating unit that is prone to high temperatures due to the high current flow, thus cooling the heating unit very efficiently.

In the heating coil according to claim 4, the second cooling medium flow path for cooling the heating unit itself is formed not only inside the annular heating unit, but also inside each of the supporting portions, and not only the heating unit, but also and the supporting portions are simultaneously cooled during the heating process of the material to be worked. Thus, a portion maintained at high temperature over a long time does not occur. Therefore, since the situation, such as a dielectric breakdown caused by carbonization and/or deterioration of the insulating plate and a damage due to stress concentration to a specific part, is less likely to occur, the heating coil according to claim 4 is excellent in durability, and can undergo the repeated heating process on the material to be worked over a long period of time even under the high output condition.

### BRIEF DESCRIPTION OF THE DRAWINGS

FIG. 1 is a perspective view of a heating coil.

FIG. 2 is a plan view of the heating coil (perspective plan view through a second cooling medium flow path inside).

FIG. 3 is a right side view of the heating coil (right side view through the second cooling medium flow path inside).

FIG. 4 is a perspective view illustrating a vertical cross-section of the heating coil (end view of line A-A of FIG. 2).

FIG. 5 is a perspective view illustrating a vertical cross-section of the heating coil (end view of line B-B of FIG. 2).

FIG. 6 is a perspective view illustrating a horizontal cross-section of the heating coil (end view of line C-C of FIG. 3).

FIG. 7 is a back view of the heating coil.

FIG. 8 is an explanatory view illustrating a state of manufacturing the heating coil (FIG. 8(a) is a plan view, and FIG. 8(b) is a vertical cross-sectional view).

### DESCRIPTION OF PREFERRED EMBODIMENTS

A heating coil according to the present invention requires to be integrally formed by a modeling method based on three-dimensional data using a three-dimensional printer. As the modeling method, a modeling method repeating laying, melting, solidifying, and laminating of a powder containing a conductive material based on three-dimensional data (partial welding lamination method of conductive material powder layer), or a modeling method laminating a melted conductive material based on three-dimensional data (melt extrusion lamination method of conductive material) can be employed. The use of the partial welding lamination method of conductive material powder layer as the heating coil modeling method is preferable because a heating coil having complicated shape and structure can be easily manufactured.

The conductive material used as a raw material of modeling in the present invention means a material that substantially does not have a magnetic property and has satisfactory conductivity. Examples of the conductive material can include copper, brass, and silver. Among these conductive materials, use of copper is preferable because the cost, such as a material cost, can be reduced to ensure easily manufacturing the heating coil at low price by a three-dimensional printer, and further, the extremely satisfactory conductivity is provided to improve a heat generation efficiency by electromagnetic induction.

When copper is used as the conductive material, while pure copper can be used, use of an alloy (high copper alloy) in which iron, tin, nickel, titanium, beryllium, zirconium, chrome, silicon, or the like is contained in copper with a lower proportion than copper is preferable because laser absorption is increased to allow accelerating temperature rise. Furthermore, among those copper alloys, use of a copper-chrome alloy in which chrome is contained in copper is more preferable because the strength of the heating coil can be effectively enhanced while the production efficiency with the three-dimensional printer is maintained to be high. Use of an alloy (high copper alloy, that is, one containing 98.71 to 99.45 mass % of copper, 0.50 to 1.00 mass % of chrome, and 0.05 to 0.25 mass % of zirconium) containing chrome and zirconium in copper with predetermined proportions is especially preferable.

When the partial welding lamination method of conductive material powder layer is used to model the heating coil according to the present invention, the laid raw material of modeling (that is, the powder containing the conductive material) needs to be melted by irradiation with a laser or electron beam. As the laser at that time, while a semiconductor laser, a carbon dioxide laser, an excimer laser, a YAG laser, a fiber laser, or the like can be appropriately used, use of the fiber laser (that is, a laser that uses an optical fiber in which a rare earth element, such as Yb, is added as a laser medium) is preferable because a laser light without deviation of optical axis can be obtained at a high output by a small-sized device, and a heating coil with high dimensional accuracy can be considerably efficiently manufactured.

When the partial welding lamination method of conductive material powder layer is used to model the heating coil, while the output and the wavelength of the fiber laser are not specifically limited, the adjustment of the output within a range of 400 to 1,000 W and the adjustment of the wavelength within a range of 1,000 to 1,100 nm are preferable because the efficient modeling in a short time can be performed. When copper (pure copper) is used as the conductive material, to improve the laser absorbance of copper powder for enhancing the production efficiency of the heating coil, an absorbent containing a mixed powder of graphite and an inorganic oxide or the like can be added to the copper powder.

The heating coil according to the present invention needs to include a pair of plate-shaped grounding portions for contact with an electrode through which a high-frequency current is flowed, a pair of plate-shaped supporting portions disposed to be perpendicular to the respective grounding portions, and an annular heating unit disposed to connect distal ends of the supporting portions to one another. While the supporting portions are not specifically limited in shape insofar as they are a pair of plate-shaped (or rod-shaped) ones disposed to be perpendicular to the respective grounding portions, those with chamfered corner portions are preferable for avoiding a discharge phenomenon when an electric power is applied.

On the other hand, while the heating unit needs to be formed in an annular shape, the heating unit is not limited to the circular one, and may be one having a non-annular shape (for example, rectangular shape in plan view) or the like. In the heating coil according to the present invention, the annular heating unit thereof need to be provided with a first cooling medium flow path for cooling the material to be worked after heating and a second cooling medium flow path for cooling the heating unit itself separately. By providing two types of the cooling medium flow paths with different purposes, it is possible to efficiently cool the material to be worked after heating and the heating unit itself at the same time.

The first cooling medium flow path for cooling the material to be worked after heating is provided with a plurality of spray holes for spraying the cooling medium to the material to be worked after heating, which further preferably improves the cooling efficiency of the material to be worked after heating. Furthermore, when the second cooling medium flow path is provided inside the first cooling medium flow path, the cooling medium (cooling liquid and the like) flowing in the second cooling medium flow path will flow down near the part where a lot of electricity flows and the temperature is easily increased. Thus, it preferably makes it possible to increase the cooling efficiency of the heating unit itself.

Further, since the heating coil according to the present invention is formed by the partial welding lamination method of the conductive material powder layer or the melt extrusion lamination method of conductive material based on three-dimensional data, the heating coil can be considerably easily manufactured although the two types of the cooling medium flow paths are formed inside the annular heating unit and the annular heating unit has the complicated shape as described above.

While the heating coil according to the present invention needs to be provided with the two types of the cooling medium flow paths as described above, it is preferable that a series of the second cooling medium flow path to flow down the cooling medium is formed in each of the supporting portions, or in each of the grounding portions and each of the supporting portions so as to be continuous with inside of the cooling medium flow path inside the heating unit. The second cooling medium flow path may be a single path disposed to connect the insides of the left and right grounding portions, the left and right supporting portions, and the heating unit, or may be two paths disposed to connect the insides of the heating unit and the supporting portions (or the insides of the heating unit, the grounding portions, and the supporting portions) in each of the left and right sides of the heating coil. In addition, the second cooling medium flow path formed without a seam or a level difference of a predetermined height or more (1.0 mm or more) on the inner wall, or formed with a bent portion and a joining portion in smooth curved shape (curved shape having a curvature radius of 5 mm or more) is preferable because the flow down aspect of the cooling medium becomes considerably smooth, and the cooling efficiency of the heating coil becomes extremely satisfactory.

### Example 1

### <Structure of Heating Coil>

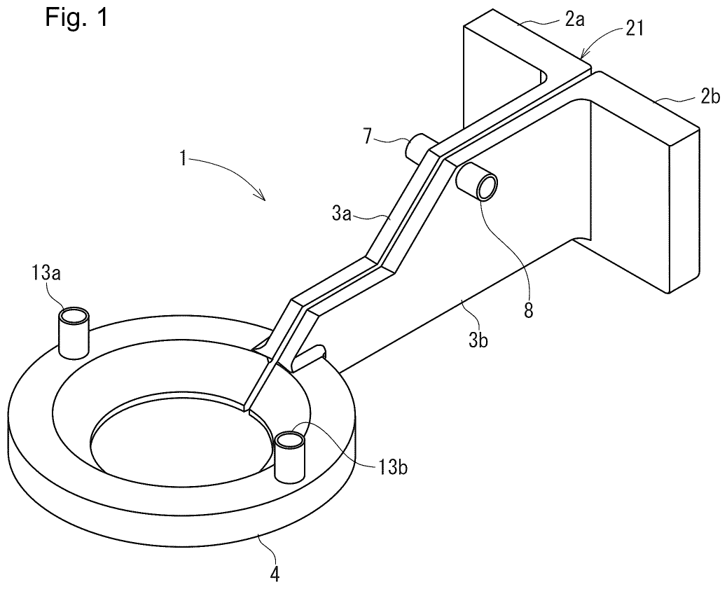

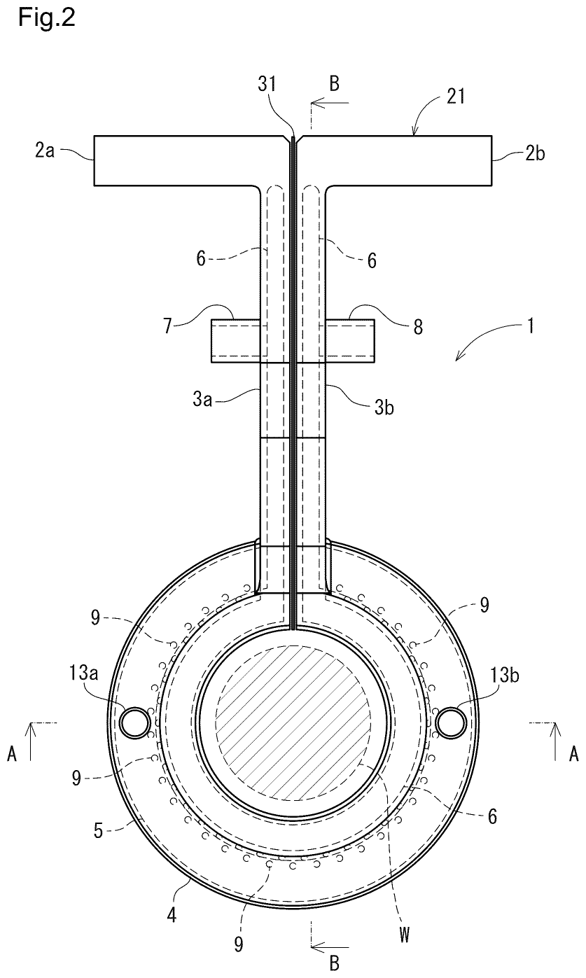

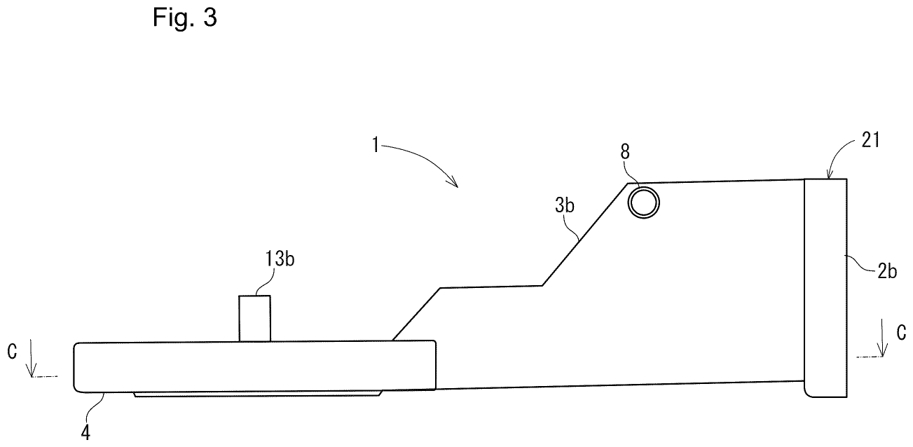

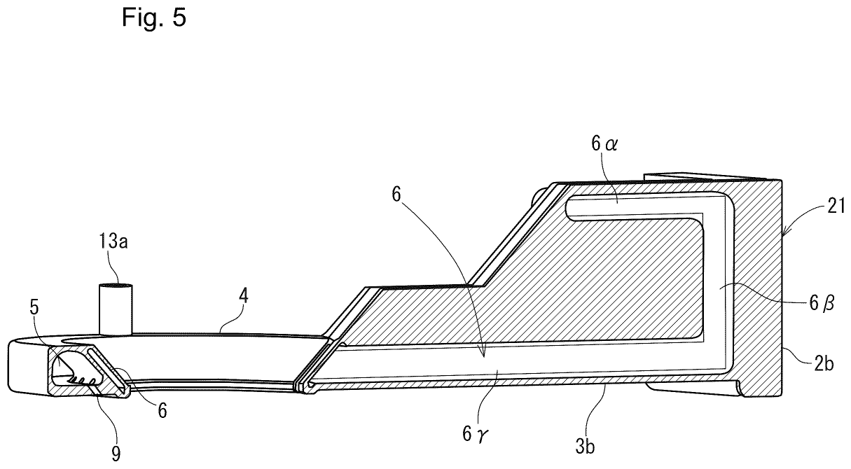

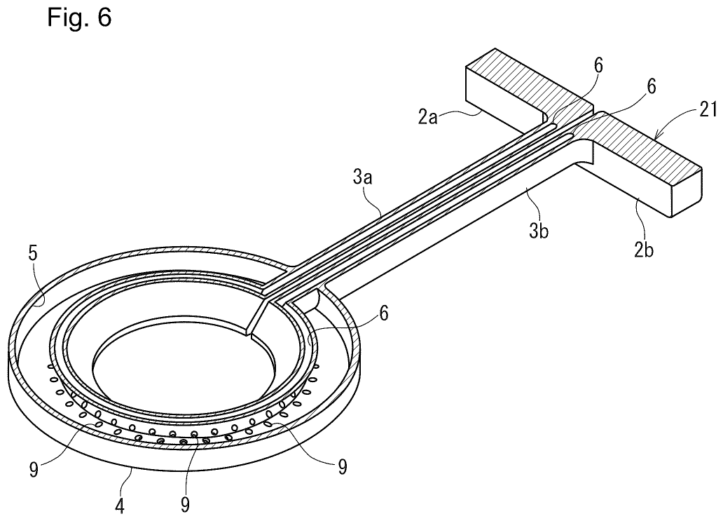

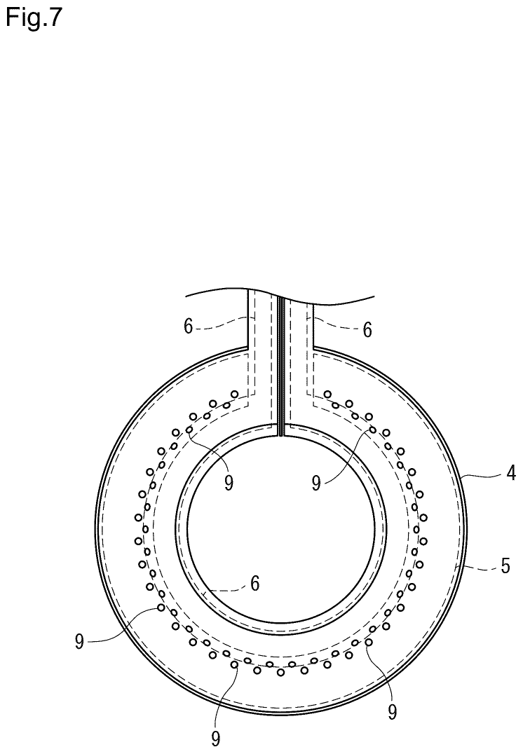

The following describes one embodiment of the heating coil according to the present invention in detail with reference to the drawings. FIG. 1 to FIG. 7 illustrate the heating coil, and a heating coil 1 includes a coil body 21 integrally formed of copper alloy (high copper alloy), a sheet-shaped insulating plate 31 formed of a synthetic resin (fluororesin) having insulating property and heat resistance, and a screw member (not illustrated). Then, the heating coil 1 has a size of longitudinal length (front-rear)×lateral length (width)×height=300 mm×150 mm×100 mm (lengths of the largest portions in longitudinal side, lateral side, and height).

The coil body 21 is formed by a modeling method using a three-dimensional printer described later, and includes grounding portions 2a, 2b for contact with an electrode of a high-frequency power supply, an annular heating unit 4 configured to heat a material to be worked (workpiece) by induction heating, and supporting portions 3a, 3b configured to support the heating unit 4 at positions apart from the grounding portions 2a, 2b, respectively. Since the coil body 21 is formed by the modeling method using a three-dimensional printer, the whole coil body 21 has the same color, and the whole surface has the same roughness (surface roughness).

The respective grounding portions 2a, 2b are formed in a pair of left and right flat rectangular parallelepiped shapes (plate shapes), and disposed to be adjacent left and right at an interval of a predetermined distance (about 2 mm) having one side surfaces facing one another.

The respective supporting portions 3a, 3b are formed in a pair of left and right flat rectangular parallelepiped shapes (plate shapes), and disposed to be adjacent left and right at an interval of a predetermined distance (about 2 mm) having one plate surfaces facing one another. Then, the base end edge portions of the supporting portions 3a, 3b are continuous with the proximities of inner end edges of the left and right grounding portions 2a, 2b, respectively, and the plate surfaces of the supporting portions 3a, 3b are perpendicular to the plate surfaces of the grounding portions 2a, 2b, respectively. In addition, a cylindrical injection pipe 7 and a discharge pipe 8 are provided above the center (center in the front-back direction) of the side surface of the supporting portions 3a, 3b, respectively, protruding to the side.

### <Structure of Heating Unit>

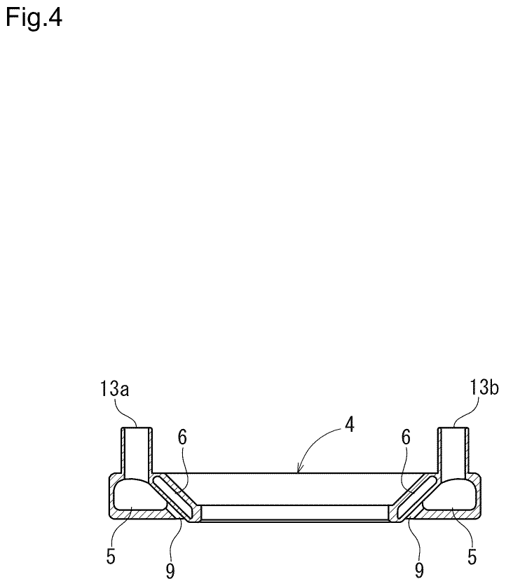

On the other hand, the heating unit 4 is used to heat the material to be worked W while the material to be worked W is being inserted, and has a ring (annular) shape with the base ends separated to the left and right. The outer circumference surface is vertical, and the inner circumferential surface is sloped such that the diameter decreases from above to below. As shown in FIG. 4, the portion at the bottom edge of the inner circumferential surface protrudes inward more than the top portion, and the inclined surface and the bottom surface form an acute angle in the vertical cross-sectional view.

In the inside of the heating unit 4, a first cooling medium flow path 5 for cooling the material to be worked W after heating by allowing a cooling medium (such as water) to flow down, and a second cooling medium flow path 6 for cooling the heating unit 4 itself by allowing a cooling medium to flow down, are provided in separate cavities. The second cooling medium flow path 6 is formed to be a flat strip (a vertical cross section has a wide rectangle with each short side that is arcuate and bulging) to extend along the sloping inner circumferential surface.

On the other hand, the first cooling medium flow path 5 is circumferentially provided outside the second cooling medium flow path 6 such that the first cooling medium flow path 5 is adjacent to the second cooling medium flow path 6. The first cooling medium flow path 5 is formed such that the lower part is wider than the upper part, and has an approximately triangular in vertical cross-sectional view. The inner side sloping surfaces are adjacent to the outer surface of the second cooling medium flow path 6 such that they are parallel to the outer surface of the second cooling medium flow path 6. Furthermore, on the bottom surface of the heating unit 4, a plurality of spray holes 9, 9 . . . of the circular cross section (cylindrical) are provided at equal intervals in double concentric circles to spray the cooling medium to the material to be worked W after heating, and the base ends of the respective spray holes 9, 9 . . . are connected to the first cooling medium flow path 5. Each of the spray holes 9, 9 . . . is inclined inwardly from above to below.

On the other hand, the top surface and the bottom surface of the heating unit 4 are horizontal, and injection pipes 13a, 13b for injecting the cooling medium from the outside are provided at opposite positions on the respective left and right sides of the top surface extending upward along the vertical direction. The left and right separated portions of the base end of the heating unit 4 are connected to the respective distal ends of the left and right supporting portions 3a, 3b.

In addition, the heating coil 1 includes the second cooling medium flow path 6 in the heating unit 4 formed not only inside the heating unit 4 but also inside the supporting portions 3a and 3b (formed as the series). That is, the cooling medium flow path 6 leads from the injection pipe 7, through the inside of the supporting portion 3a on the left side, through the inside of the heating unit 4 (that is, from the base end of the left side to the base end of the right side via the distal end portion), and through the inside of the supporting portion 3b on the right side to the discharge pipe 8 on the right side. The second cooling medium flow path 6 forms each of an upper side horizontal portion 6a, a vertical portion 6B, and a lower side horizontal portion 6y in the inside of the right and left supporting portions 3a and 3b and passes through the base end of the right and left grounding portions 2a and 2b.

Since the heating coil 1 is integrally formed by a three-dimensional printer, all the bend portions and the connected portions of both the first cooling medium flow path 5 and the second cooling medium flow path 6 are formed in a gently curved shape (a curved shape with a radius of a curvature of 5 mm or more), without any steeply bent shape formed. In addition, neither the first cooling medium flow path 5 nor the second cooling medium flow path 6 has any seam nor level difference of a predetermined height (1.0 mm) or more on the inner wall.

Furthermore, a sheet-shaped insulating plate 31 of a predetermined thickness (approximately 2.0 mm) is sandwiched between the left and right grounding portions 2a and 2b of the coil body 21, between the left and right supporting portions 3a and 3b, and between the left and right base portions of the heating unit 4. In this state, the left and right supporting portions 3a and 3b and the insulating plate 31 are screwed together by bolts inserted through the screw holes (not shown in the figure). These bolts screw the supporting portions 3a, 3b and the insulating plate 31 together via bushes (not illustrated) made of a synthetic resin (glass epoxy resin) having insulating property and heat resistance, and are configured to avoid conduction between the supporting portions 3a and 3b via the bolts.

### <Manufacturing Method of Heating Coil>

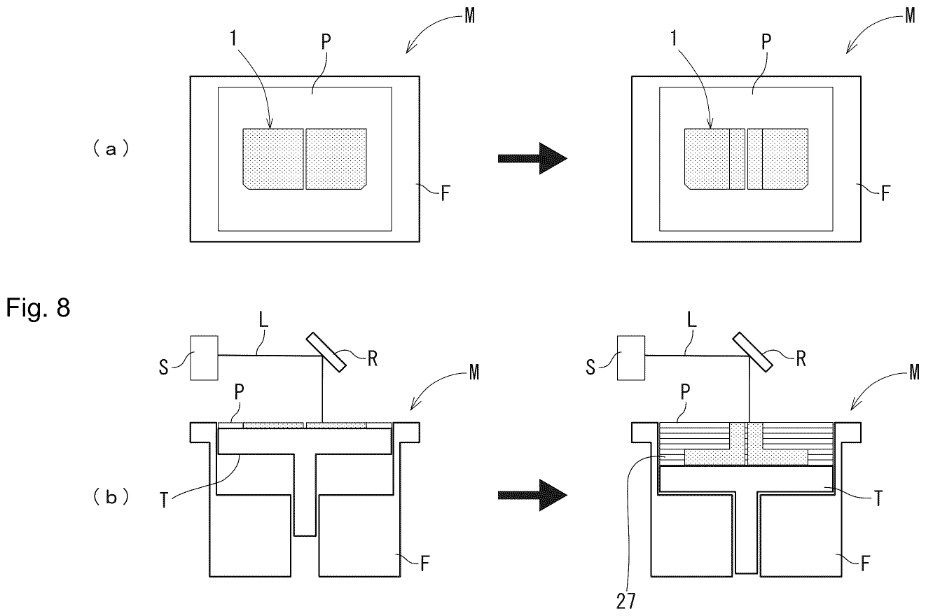

FIG. 8 illustrates a state of forming the heating coil 1 (the coil body 21), and a three-dimensional printer device M for forming the heating coil 1 includes a frame F provided with a rectangular parallelepiped recessed portion in the center, an elevating member disposed to be movable up and down with respect to the frame F, irradiation means S configured to emit a laser L, reflection means R configured to reflect the laser, and driving means (not illustrated) configured to move up and down the elevating member. Furthermore, the elevating member is provided with a table T having approximately the same area as an opening portion of the recessed portion of the frame F.

In the manufacture of the heating coil 1 by the three-dimensional printer device M, first, a powder of copper alloy (high copper alloy) is laid with a predetermined thickness (for example, 30 μm) on the surface of the table T of the elevating member at an elevated position (the copper powder is laid by an amount of a gap between the surface of the table T and a surface of an outer frame of the frame F). Then, the copper alloy powder is irradiated with the laser (fiber laser) L of a predetermined output in a predetermined shape to melt a part of the copper alloy powder, which is cooled and solidified, thereby forming a part of the heating coil 1.

After the formation of a part of the heating coil 1 as described above, the table T of the elevating member is moved down by a predetermined height (for example, 30 μm) by the driving means. Then, at the height position, the operation of “laying the copper alloy powder→irradiating the copper alloy powder with the laser L→cooling and solidifying the melted copper alloy (solidification by coagulation) at the upper side of the part of the previously formed heating coil 1” is repeated. Then, as described above, the operation of “moving down the table T of the elevating member→laying the copper alloy powder→irradiating the copper alloy powder with the laser L→cooling and solidifying the melted copper alloy” is repeated by a predetermined number of times (for example, 5,000 times), thereby allowing integrally forming the heating coil 1 made of a copper alloy.

### <Use Method of Heating Coil>

The heating coil 1 configured as described above can heat the material to be worked W by grounding the left and right grounding portions 2a, 2b to the electrodes and having the material to be worked W inserted inside the annular heating unit 4, with the external power supply (high-frequency power supply) turned on via the electrodes and using the electromagnetic induction phenomenon. In addition, injecting the cooling medium (water) from the injection pipes 13a, 13b into the first cooling medium flow path 5 and spraying it from the spray holes 9, 9 . . . to the workpiece W allows efficiently cooling the workpiece W after heating. Furthermore, at the same time as cooling the material to be worked W as described above, the cooling medium (water) is injected from the injection pipe 7 into the second cooling medium flow path 6 inside the supporting portion 3a on the left side, passing through the inside of the heating unit 4 and then through the inside of the supporting portion 3b on the right side before being drained from the discharge pipe 8, thereby efficiently cooling the heating unit 4 and the supporting portions 3a, 3b. This can prevent damage and the like due to melting of the insulating plate 31 with high precision.

### <Effect of Heating Coil>

The heating coil 1 includes, as described above, the pair of plate-shaped grounding portions 2a, 2b for contacting the electrodes to which the high-frequency current is applied, the pair of plate-shaped supporting portions 3a, 3b arranged perpendicularly to the respective grounding portions 2a, 2b, and the annular heating unit 4 provided to connect the distal ends of the supporting portions 3a, 3b. The annular heating unit 4 includes the first cooling medium flow path 5 for cooling the material to be worked W after heating and the second cooling medium flow path 6 for cooling the heating unit 4 itself separately. Therefore, with the heating coil 1, the cooling of the material to be worked W after heating and the cooling of the heating unit 4 itself can be performed efficiently at the same time, and even if the heating coil 1 continues to be used under high output conditions, a situation of damage can be prevented with high accuracy.

Further, since the heating coil 1 is formed by the modeling method (that is, the partial welding lamination method of the conductive material powder layer based on the three-dimensional data) using the three-dimensional printer device M, the heating coil 1 can be considerably easily manufactured regardless of the complicated shape of the annular heating unit 4. Moreover, products having the same shape and the same property can be efficiently manufactured with good reproducibility regardless of the skill of manufacturing workers. Furthermore, since the heating coil 1 is formed by the modeling method using the three-dimensional printer device M, a bonding portion with a silver wax is not present as in the case of the conventional heating coil. Therefore, even the temperature rise due to the continuous use does not cause deformation, and the heating process (quenching treatment) according to specifications can be performed over a long period of time.

Furthermore, in the heating coil 1, the first cooling medium flow path 5 is provided with a plurality of spray holes 9, 9 . . . for spraying the cooling medium to the material to be worked W after heating. Thus, the material to be worked W after heating can be cooled efficiently within a short time with a small amount of cooling medium.

In addition, the heating coil 1 includes the second cooling medium flow path 6 inside the first cooling medium flow path 5. Thus, the cooling medium flows down near the part of the heating unit 4 that is prone to high temperatures due to the high current flow, thus cooling the heating unit 4 very efficiently.

In the heating coil portion 1, a part of the second cooling medium flow path 6 is formed not only inside the heating unit 4 but also inside each of the supporting portions 3a, 3b. Thus, not only the heating unit 4 but also each of the supporting portions 3a, 3b (and each of the grounding portions 2a, 2b) is simultaneously cooled during the heating process of the material to be worked W. This prevents the heating coil 1 from being held at high temperatures over a long time. Therefore, since situation such as dielectric breakdown caused by carbonization and deterioration of the insulating plate 31 and damage due to stress concentration in a specific part do not occur, the heating coil 1 has excellent durability and can repeatedly heat the material to be worked W for a long period of time even under high output conditions.

The heating coil 1 includes the injection ports 13a, 13b for injecting the cooling medium into the first cooling medium flow path 5 at the heating unit 4, and the heating unit 4 likely to become the highest temperature can be supplied with the cooling medium at low temperature immediately after introduction from the water source. Therefore, the heating coil 1 is extremely excellent in cooling efficiency, and can be used in a state of being applied with the high-frequency power supply at a considerably high output.

### <Modification of Heating Coil>

The heating coil according to the present invention is not limited to the above-described aspect of the embodiment, and the configuration, such as a material, and shapes and structures of the grounding portions, the supporting portions, and the annular heating unit, the first cooling medium flow path, and the second cooling medium flow path can be appropriately changed as necessary without departing from the gist of the present invention.

For example, the heating unit of the heating coil is not limited to have a simple circular annular shape as the above-described embodiment, but can be changed to a rectangular annular shape in plan view, or a divided annular shape arranged horizontally above and below and connected by a vertical columnar body.

The heating unit is not limited to the first cooling medium flow path being triangular in a vertical cross-sectional view or the second cooling medium flow path being a flat strip as the above-described embodiment, and the shape of the first cooling medium flow path and/or the second cooling medium flow path can be changed as necessary. By providing the first cooling medium flow path and the second cooling medium flow path adjacent to each other via the plate-shaped body as the above-described embodiment, it is possible to achieve better efficiency in cooling the material to be worked after heating and in cooling the heating unit itself.

Furthermore, the heating coil according to the present invention is not limited to one including a single second cooling medium flow path as the above-described embodiment, and may be changed to one including a plurality of second cooling medium flow paths (for example, one including a second cooling medium flow path on the left side leading from the injection pipe on the left side through the supporting portion on the left side to the heating unit and then to the discharge pipe on the left side at the distal end of the heating unit and a second cooling medium flow path on the right side leading from the injection pipe on the right side through the supporting portion on the right side to the heating unit and then to the discharge pipe on the right side at the distal end of the heating unit). Furthermore, the heating coil according to the present invention is not limited to one in which the second cooling medium flow path is provided only inside the heating unit and the supporting portion as in the above embodiment, but can also be changed to one in which the second cooling medium flow path is provided inside the heating unit, the supporting portion, and the grounding portion. In addition, the heating coil according to the present invention is not limited to one in which the second cooling medium flow path has a simple straight or curved shape as the above-described embodiment, but can also be changed to one in which the second cooling medium flow path is zigzag bent (tortuous), one in which the second cooling medium flow path branches inside the supporting portion (or/and grounding portion), and the like.

Furthermore, the heating coil according to the present invention is not limited to one in which a single first cooling medium flow path is provided as the above-described embodiment, but can be changed to one in which the first cooling medium flow path is divided into a plurality of sections by partition plates or the like.

In addition, the heating coil according to the present invention is not limited to one in which the insulating plate made of a fluororesin (PTFE, PFA, FEP, ETFE, PCTFE, ECTFE, PVDF) insulates between a pair of grounding portions and between a pair of supporting portions as the above-described embodiment, and may be changed to, for example, one in which the insulating plate made of another synthetic resin having insulation property and heat resistance, such as polyacetal (POM), polyphenylene sulfide (PPS), and polyetheretherketone (PEEK), insulates between the pair of grounding portions and between the pair of supporting portions.

### INDUSTRIAL APPLICABILITY

The heating coil according to the present invention provides the excellent effects as described above, and therefore, can be appropriately used as a member for heating a material to be worked using electromagnetic induction.

### DESCRIPTION OF REFERENCE SIGNS

1 . . . Heating coil
2a, 2b . . . Grounding portion
3a, 3b . . . Supporting portion
4 . . . Heating unit
5 . . . First cooling medium flow path
6 . . . Second cooling medium flow path
7 . . . Injection pipe
8 . . . Discharge pipe
9 . . . Spray hole
13a. 13b . . . Injection pipe

1. A heating coil used for a high-frequency heater for heating a material to be worked using electromagnetic induction by a high-frequency current, wherein
the heating coil is integrally formed by a modeling method repeating laying, melting, solidifying, and laminating of a powder containing a conductive material based on three-dimensional data, or a modeling method laminating a melted conductive material based on three-dimensional data, and
the heating coil comprises:
a pair of plate-shaped grounding portions for contact with an electrode through which a high-frequency current is flowed;
a pair of plate-shaped supporting portions disposed to be perpendicular to the respective grounding portions; and
an annular heating unit disposed to connect distal ends of the supporting portions to one another, wherein
the annular heating unit includes a first cooling medium flow path for cooling the material to be worked after heating and a second cooling medium flow path for cooling the heating unit itself separately.

2. The heating coil for a high-frequency heater according to claim 1, wherein
the first cooling medium flow path includes a plurality of spray holes for spraying the cooling medium to the material to be worked after heating.

3. The heating coil for a high-frequency heater according to claim 1 or 2, wherein
the second cooling medium flow path is disposed inside the first cooling medium flow path.

4. The heating coil for a high-frequency heater according to any one of claims 1 to 3, wherein
a portion of the second cooling medium flow path is formed inside each of the supporting portions.
